(19) United States
(12) Patent Application Publication
(10) Pub. No.: US 2014/0016911 A1
(43) Pub. Date: Jan. 16, 2014

(54) MULTI-LOCATION DVR ACCESS CONTROL

(71) Applicant: James Edwin Hailey, Indianapolis, IN (US)

(72) Inventor: James Edwin Hailey, Indianapolis, IN (US)

(73) Assignee: THOMSON LICENSING, Issy de Moulineaux (FR)

(21) Appl. No.: 14/007,416

(22) PCT Filed: May 3, 2011
(86) PCT No.: PCT/US11/00773

§ 371 Date: Sep. 25, 2013

(51) Int. Cl. H04N 9/87

(52) U.S. Cl. CPC H04N 9/87
USPC 386/234; 386/261

(57) ABSTRACT

A home multimedia net-work (10, 100) having display devices (121-12n) at multiple locations, can afford a user the ability to pause the play-back of previously recorded content at one location and later resume content playback at another location. To prevent the resumption of playback of content inappropriate for certain locations (e.g., a child's bedroom), the home multimedia network advantageously affords the user the ability to restrict selected locations from resuming playback by establishing a list of permissible locations able to receive paused previously recorded content.

### TECHNICAL FIELD

This invention relates to a technique for controlling access to content playback at a plurality of locations.

### BACKGROUND ART

The delivery of video content has evolved from the distribution of a fixed set of programs available only at specific times to offering video content for downloading at any time. In large measure, advancements in recording technology have enabled any-time delivery of content. The development of digital, non-linear recording devices (hard disk drives) capable of storing large quantities of video content, as well as the development of video compression standards such as MPEG-2 and now H.264 has enabled the transport and recording of full length motion pictures and other types of audio-visual programs for any-time delivery.

Many providers of video content, such as cable and satellite television providers, now offer set-top boxes with a built-in recording device, thereby allowing a user to record programs for later viewing. Some video content providers also offer users the ability to record content on a recording device within the provider's network, usually referred to as “network-based recording”. Users can also record content on outboard recording devices, such as personal computers, cell phones, and other such devices for play back through the set-top box.

In addition to offering the user the ability to record content, many content providers now offer users the ability to share content among multiple locations in a common premise, such as a home. This content sharing ability of a set-top box allows it to function as a “whole-house” device, spawning features such as Pause-Transfer-Un-pause that allows a user initiate viewing of a program in one location, then pause the program and later un-pause the program for playback at another location. Presently, the Pause-Transfer-Un-pause feature associated with whole-house set-top boxes allows any user at any location to un-pause the program for viewing. Assuming that the whole house set-top-box allows for wireless access by a mobile device, a user of such a mobile device can also un-pause the content at any location.

In some instances, recorded content available for multi-location viewing using the Pause-Transfer-Un-pause feature may lack suitability for viewing by all members of a household. For example a movie containing adult content may lack suitability for viewing by young children. However, present-day set-top boxes that offer the Pause-Transfer-Un-pause function lack parental control to prevent the un-pausing of content at a particular location.

Some content providers afford users the ability to restrict the viewing based on a rating associated with such content. For example, movies typically will have one of the following ratings: G (for general audiences), PG (parental guidance suggested), PG-13 (parental guidance suggested but in appropriate for children less than 13 years old) and R (restricted). However, such ratings do not always serve as good indicator as to the desirability of viewing by children. Content not having any rating can contain topics only suitable for adults. Preventing the un-pausing of all unrated content generally does not offer a viable solution. Many children's shows lack a content rating and thus could not be un-paused by a child in the absence of a password. The same issue exists when content providers allow up-pausing of content by a mobile device since many members of the family can possess such devices.

Thus, a need exists for a technique for controlling multi-location digital video recorder access.

### BRIEF SUMMARY OF THE INVENTION

Briefly, in accordance with a preferred embodiment of the present principles, a method for controlling access to recorded content at multiple locations within a common premise commences by determining, in response to an un-pause command to initiate playback at one location of recorded content previously paused at another location, whether the one location is authorized to receive the content. If so, playback of the paused recorded content at the one location is initiated.

### BRIEF SUMMARY OF THE DRAWINGS

FIG. 1 depicts a block schematic view of a first exemplary network of connected display devices suitable for practicing the recording device access control technique in accordance with the present principles;

FIG. 2 depicts a block schematic view of a second exemplary network of connected display devices suitable for practicing the recording device access control technique in accordance with the present principles; and

FIG. 3 depicts, in flow chart, the steps of a method for establishing permissions for to access recorded content at different locations.

### DETAILED DESCRIPTION

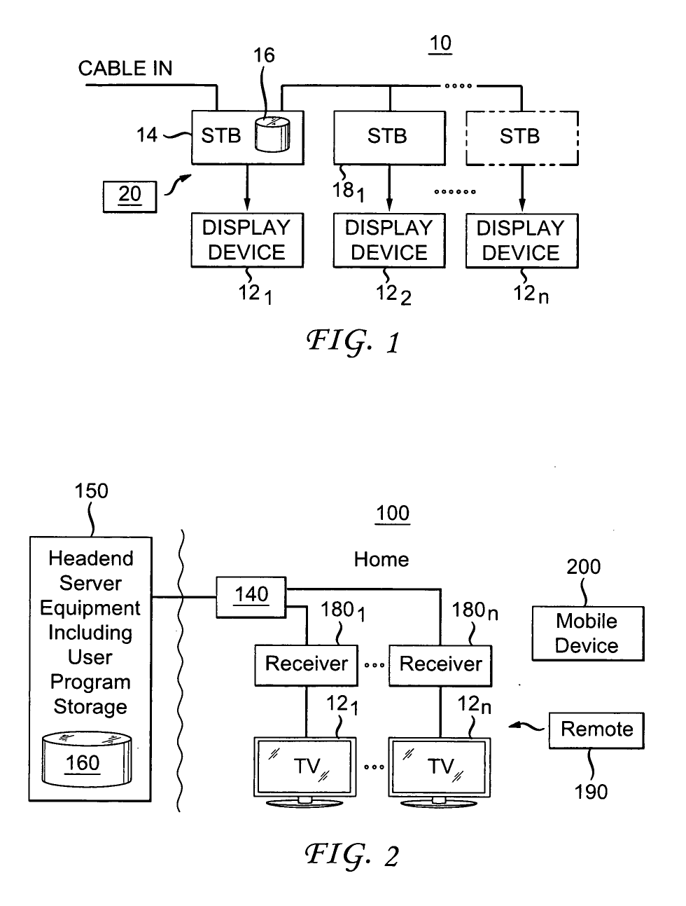

FIG. 1 depicts a block schematic diagram of first exemplary network 10 for distributing content, typically in the form of audio-visual programs (e.g., movies and television programs), to a plurality of audio-visual display devices (e.g., television sets) 12₁-12ₙ where n is an integer greater than zero. Typically, each of the display devices 12₁-12ₙ resides in a different location within a common premise. For example, each of the display devices typically resides within a different room within a home.

The network 10 includes a master content selection device 14, typically in the form of a set-top box having an associated recording device 16, such as a hard disk or the like, either built-in to, or outboard from the set-top box. In practice, the master set-top box 14 receives audio visual content from a network service provider, such as a cable or satellite television provider. The master set-top box 14 delivers content to an associated display device, for example, display device 12₁. In addition, the master set-top box 14 has the capability to deliver content to one or more slave set-top boxes, exemplified by slave set-top box 18₁. In practice, the master and slave set-top boxes make use of the home multi-media network standard established by the Multimedia over Cable Alliance (MoCA) to permit the sharing of content as among devices. Other network standards that permit the sharing of content among content selection devices such as set-top boxes could be used as well.

Just as the Master set-top box 14 delivers content to a corresponding display device (e.g., display device 12₁), each slave set-top box likewise serves to deliver content to a corresponding display device. Thus, for example, slave set-top box 18₁ delivers content to display device 12₂. In some instances a display device, such as display device 12ₙ will possess the necessary structure and functionality to obviate the need for a slave set-top box, as indicated by the slave set-top box shown in phantom in FIG. 1. Under such circumstances, the display device 12ₙ will receive content directly from the master set-top box 14, rather than via a slave-set-top box. The distribution of content from the master set-top box 14 to the slave set-top boxes, such as slave set-top box 18₁ typically occurs over coaxial cable, although other communication links, either wired or wireless could serve this function as well.

Within a typical home multimedia network, such as network 10 of FIG. 1, the master set-top box 14 allows a user to pause playback of previously recorded content displayed on a first display device and thereafter, resume (i.e., unpause) content playback on another display device. Typically, a user pauses content playback on the display device 12₁ by entering an appropriate command to the master set-top box 14 associated with that display device via a remote control 20. Thereafter, the user will enter the appropriate command to one of the slave set-top boxes, for example slave set-top box 18₁, via a remote control (not shown) to un-pause (e.g., resume) playback of the recorded content on the display device 12₂ at another location of the home. The phrase “pause-transfer-un-pause” often serves as a short hand description of the process of pausing of content playback at one location, and the later resuming the playback at another location.

FIG. 2 depicts a block schematic diagram of a second exemplary embodiment of a home multimedia network 100 for delivering content to a plurality of audio visual display devices 12₁-12ₙ (e.g. television sets). The network 100 includes a gateway 140 coupled to a head end 150 of a content provider network. The gateway 140 receives content from the head-end 150 and distributes the content to each of a plurality of content selection devices, typically set-top boxes 180₁-180ₙ (where n is an integer). Each set-top box provides content to a corresponding one of the television sets 12₁-12ₙ.

Unlike the network 10 of FIG. 1, the network 100 of FIG. 2 lacks a recording device. Rather the head end 150 maintained by the content service provider typically includes one or more recording devices 160 responsive to commands received from network 100 to record and replay content. In particular, a user can enter an appropriate command via one a remote control 190 to one the set-top boxes 180₁-180ₙ for transmission to the head-end 150 via the gateway 140 to initiate either the recording or playback of content. Like the network 10 of FIG. 1, the network 100 permits the pausing of content undergoing display on a first display device 12₁ and the resumption of the display on a second display device 12ₙ. In other words, the network 100 of FIG. 2 possesses the pause-transfer-un-pause feature like network 10 of FIG. 1. Typically, a user pauses or un-pauses the playback of content in the network 100 of FIG. 2 by entering an appropriate command to one of the set-top boxes through the remote control 190. The set-top boxes 180₁-180ₙ, as well as the gateway 140 could respond also to respond to a pause command entered though another device, such as mobile device 200, such as a cell phone, personal data assistant or a tablet device with wireless capability for example. Depending on the nature of the wireless connection, a user could use his/her mobile device 200 from a remote location to unpause content at a location within the home.

The ability of pause the playback of content on a display device in one location and thereafter resume playback on a display device at another location can prove problematic with respect to the nature of the content and those individuals able to initiate the playback at a given location. For example, a parent could initiate playback of content having an adult theme at a first location (e.g., a den) and thereafter pause the content with the intent of resuming playback once the parent enters the master bedroom. However, the pause-transfer-un-pause feature available in present day home multimedia networks allows a user at any location served by the network to un-pause content.

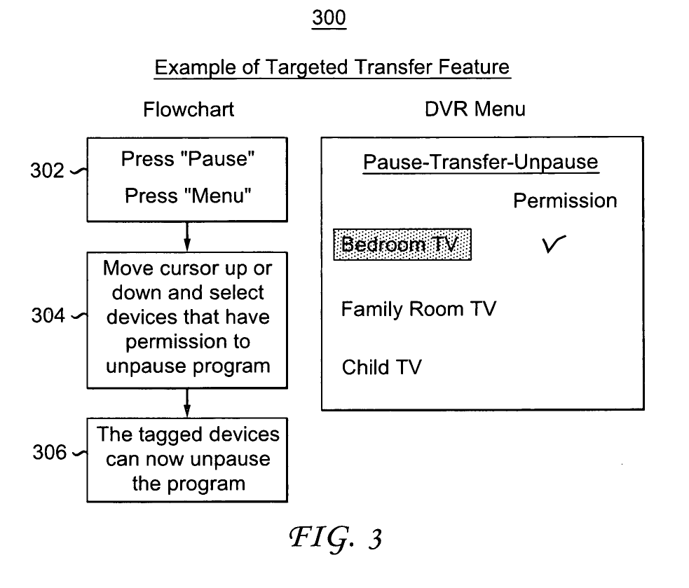

In accordance with the present principles, the networks 10 of FIG. 1 and 100 of FIG. 2 afford a user the ability to restrict the locations from which a user can initiate the resumption of content playback. FIG. 3 depicts in flow chart form the steps of a method 300 by which a user can establish permissions for the devices (e.g., set top boxes or display devices) at those locations from which a user can resume (e.g., un-pause) the playback of content. The method 300 commences upon step 302 at which time the user will initiate a Pause command to inhibit content playback. Thereafter, the user will initiate a command to obtain a menu of locations having display devices where content can undergo playback following receipt of a un-pause command. During step 304, the user will grant permission to those devices (e.g. set-top boxes) associated with the locations where un-pausing of content is permissible. The user can view the list of locations by scrolling. Thus, for example, a user can grant permission for the set-top box in the master bed-room, but not grant permission to the set-top in the family room or children's bedroom. Further, the user can grant permission to certain mobile devices, but not others. By the same token, the user could exclude devices to render them specifically incapable of un-pausing content in the absence of a password or pin. Once the user has selected those devices with permission to un-pause content, then upon receipt of an un-pause command at such a device during step 304, content playback will occur.

The step-method 300 of FIG. 3 can include additional enhancements. For example, before the user can give permissions during step 302, user authentication could occur, requiring the entry of a password or personal identifier (PIN). Further, the set-up method of FIG. 3 could automatically exclude certain locations, even in the absence of user entries, based on the time of day, or the rating associated with the content. For example, after a certain time in the evening, any location likely occupied by a child such as a child's bedroom or the family room will automatically lack permission to un-pause content. Moreover, the permissions given during step 302 could also include devices which are location independent. For example, a user could grant or deny permission to unpause content playback to a mobile device (e.g. a child's cell phone).

The foregoing describes a technique for controlling access to content playback at a plurality of locations.

1. A method for controlling access to previously recorded content at multiple locations, comprising the steps of:
determining whether a user is authorized to resume playback of the previously recorded content at one location, which content had been previously paused at another location, and if so
initiating playback of the paused previously recorded content at the one location.

2. The method according to claim 1 wherein the determining step includes the step of determining whether the one location is authorized to resume content playback based on a rating associated with the content.

3. The method according to claim 1 wherein the determining step includes the step of determining whether the one location is authorized to resume playback based on time of day.

4. The method according to claim 1 wherein the determining step includes the step of determining whether the one location is authorized to resume playback in accordance with a list of user established location permissions.

5. The method according to claim 1 wherein the step of initiating playback of the previously recorded includes the step of receiving an un-pause command from a remote control.

6. The method according to claim 1 wherein the step of initiating playback of the previously recorded content includes the step of receiving an un-pause command from a mobile device.

7. Apparatus for controlling access to previously recorded content at multiple locations, comprising the steps of:
means for determining whether a user is authorized to resume playback of the previously recorded content at one location, which content had been previously paused at another location, and if so
means for initiating playback of the paused previously recorded content at the one location.

8. The apparatus according to claim 7 wherein the determining means determines whether the one location is authorized to resume content playback based on a rating associated with the content.

9. The apparatus according to claim 7 wherein the determining means determines whether the one location is authorized to resume playback based on time of day.

10. The apparatus according to claim 7 wherein the determining means determines determining whether the one location is authorized to resume playback in accordance with a list of user-established location permissions.

11. The apparatus according to claim 7 wherein the means to initiate playback of the previously recorded responds to a an un-pause command from a remote control.

12. The apparatus according to claim 7 wherein the means to initiate playback of the previously recorded responds to a an un-pause command from a mobile device.
